(19) United States
(12) Patent Application Publication
(10) Pub. No.: US 2013/0080589 A1
(43) Pub. Date: Mar. 28, 2013

(54) IMAGE-BASED DATA SHARING SYSTEM AND ITS EXECUTIVE METHOD

(71) Applicants: Hong-Chi YU, Kaohsiung City (TW); Mao-Ting Chang, Kaohsiung City (TW)

(72) Inventors: Hong-Chi YU, Kaohsiung City (TW); Mao-Ting Chang, Kaohsiung City (TW)

(73) Assignee: WALTON ADVANCED ENGINEERING INC., Kaohsiung (TW)

(21) Appl. No.: 13/307,355

(22) Filed: Nov. 30, 2011

(30) Foreign Application Priority Data
Sep. 22, 2011 (TW) 100134092

(51) Int. Cl. G06F 15/16

(52) U.S. Cl. 709/218

(57) ABSTRACT

The present invention is intend for data sharing completed via Internet or local area networks when at least one data storage device is electrically connected to a digital box and the digital box links a server. At the moment, an image is caught by one image capture device of a computer which is equipped with one application program and decoded by a decoder module in order to get a peer authentication code. Then, one command to read out, write in, modify, delete or add any data/file in a data storage device which is electrically connected to a digital box or any data/file in a storage space is executed by one user via the computer when peer authentication codes of the computer and the digital box are identified as the same group by the server.

### BACKGROUND OF THE INVENTION

1) Field of the Invention

The present invention relates to a data sharing system and its executive method, especially an image-based data sharing system and its executive method.

2) Description of the Prior Art

At present, a USB flash disk is the most popular tool for delivery of data/files between computers. A user who intends to copy any data/file of Computer A into Computer B should electrically connect a USB flash disk to Computer A prior to data of Computer A saved in the USB flash disk and then electrically connect the USB flash disk to Computer B for stored data copied or moved to Computer B for the data/file in Computer A shared by Computer B.

However, there are still some problems existing in the method for files transmitted between computers by a USB flash disk: (1) Data/file not immediately, efficiently and conveniently shared due to an actual distance between computers; (2) Data transfer efficiency simply reduced by 50% during a procedure of the same data/file transmitted twice in the way of a two-stage “copy in & copy out” for the data/file accessed by a USB flash disk; (3) Difficulty in confused versions of any data/file which has been duplicated multiply; (4) Failure in backup of any data/file with its version not effectively controlled by one user.

For applications of a USB flash disk without restrictions of distances or transfer efficiency, these said problems with respect to delivery of data/files via a USB flash disk still remain to be overcome.

### SUMMARY OF THE INVENTION

To solve the said problems, the present invention provides an image-based data sharing system and its executive method which depends on Internet or local area networks for data sharing and comprises at least an image, at least a digital box, at least a server and an application program: (1) An image caught by a computer's image capture device is decoded by an application program's decoder module in order to catch a peer authentication code; (2) Any data/file in a data storage device which is connected to a digital box's data communications interface could be modified, read out and written in by one computer in the event of both the computer's and the digital box's peer authentication codes identified as the same group by a server.

Accordingly, the principal object of the present invention is to embody any data/file in a data storage device which is connected to a digital box's data communications interface could be modified, read out and written in by one user who uses one computer catching a peer authentication code from an image via Internet or local area networks for data/file sharing unrestricted to a distance between one digital box and one computer and any data/file shared easily, effectively and conveniently.

The other object of the present invention is to avoid one single file multiply duplicated and saved in different computers or data storage devices and substantially improve management of one single file with multiple versions. Therefore, a user could effectively organize and manage files/data and the update history.

The further object of the present invention is to keep data security because any data/file in the digital box's data storage device is modified, read out and written in by one computer whose authentication code and the digital box's belong to the same group.

To this end, the present invention has the principal technical measures delivered with the following techniques. The present invention is designed to be an image-based data sharing system which depends on Internet or local area networks for data sharing and comprises at least an image, at least a digital box, at least a server and an application program: the image generated from a specific encoding process expresses its content comprising at least a peer authentication code; the digital box connected to the server comprises at least a data communications interface, at least a memory unit, at least a control unit, a peer authentication code saved in the memory unit, and at least a file list; the data communications interface is electrically connected to at least a data storage device; the server comprises at least a grouped peer management list used to manage and confirm the peer authentication codes in the same group; at least a file management list is used to manage the file list uploaded to the server; the application program comprises an image capture module which is used in driving a computer's one image capture device; a decoder module executes a decoding process in order to catch the peer authentication code with the image retrieved by the image capture device; a connector module used to connect and provide the peer authentication code to the server; any data/file in a data storage device which is connected to a digital box's data communications interface could be modified, read out and written in by one computer in the event of both the image's and the digital box's peer authentication codes identified as the same group by a server based on the grouped peer management list.

The purposes and the technical issues with respect to the present invention are further embodied with the following technical measures.

In the said image-based data sharing system, the digital box's memory unit comprises a storage space which is used to store any data/file.

In the said image-based data sharing system, the memory unit comprises a programmable firmware which has a file complier module used to compile any data/file of the data storage device that is connected to the digital box or any data/file of the storage space into the file list.

In the said image-based data sharing system, the programmable firmware comprises a connection module which is executed by the control unit for both the peer authentication code and the file list provided to the server.

In the said image-based data sharing system, the image expresses its content comprising at least a server's position, a user name or a password or a combination of the server's position, the user name or the password.

In the said image-based data sharing system, a user interface offered by the application program is exported to the computer's one display unit and used to display the server's file management list when the image's and the digital box's peer authentication codes are identified as the same group by the server.

In the said image-based data sharing system, a command to modify, read out, write in or add the data/file in data storage device which is displayed on the file management list or the data/file in the storage space can be issued by one user who depends on the user interface and the computer.

In the said image-based data sharing system, the digital box's data communications interface could be any data communications interface among eSATA (External Serial ATA), eSATAp (power over eSATA) and USB (Universal Serial Bus) or a combination of these interfaces thereof.

In the said image-based data sharing system, a decoding process executed by the decoder module is to decode the caught image and deliver the decoded peer authentication code to the computer.

In the said image-based data sharing system, a decoding process executed by the decoder module is to supply the image caught by the connection module to the server for decoding and the decoded peer authentication code delivered to the computer.

In the said image-based data sharing system, the image could be 1-dimensional (1D) barcodes or international standard 2-dimensional (2D) barcodes among Code16K, Supercode, Code49, QR code, PDF417, DataMatrix, Maxicode, Aztec, Vericode, Softstrip, Codel, CP, Codablock F, Ultracode, and Philips Dot Code.

The executive method of the image-based data sharing system in the present invention dependent on Internet or local area networks for data sharing comprises steps as follows. Step 1: The data storage device is electrically connected to the digital box; Step 2: The connection module is executed by the control unit of the digital box for both the peer authentication code and the file list connected and supplied to the server; Step 3: The application program is installed in and executed by the computer; Step 4: An image is caught by the image capture device and decoded by the decoder module in order to get a peer authentication code; Step 5: A peer authentication code is caught and supplied to the server by the connector module; Step 6: The server identifies the peer authentication code via the grouped peer management list; Step 7: A user interface provided by the application program is exported to the computer's one display unit and used to display the file management list from the server when the image's and the digital box's peer authentication codes are identified as the same group by the server; Step 8: A command to modify, read out, write in or add any data/file which has been displayed on the file management list and saved in the data storage device or any data/file in the storage space is issued by one user via the user interface and the computer.

In contrast to prior arts, the present invention is effective in: (1) Data sharing unrestricted to a distance between a digital box and a computer (which has retrieved an image's peer authentication code) and data easily, effectively and conveniently shared; (2) Files/data effectively managed and updated by one user to substantially eliminate difficulty in data management for one single file duplicated multiply; (3) Data security because of modification, read-out or write-in of any data/file in the data storage device, which is connected to the digital box, only available in a computer's and a digital box's peer authentication codes belonging to the same group.

### BRIEF DESCRIPTIONS OF THE DRAWINGS

FIG. 1 illustrates operation of an image-based data sharing system and its executive method in the present invention.

FIG. 2 is the block diagram of an image-based data sharing system and its executive method in the present invention.

FIG. 3a is the flow diagram to start up an image-based data sharing system and its executive method in the present invention.

FIG. 3b is the flow diagram for modification (addition, deletion, etc.) of any data/file in the present invention of an image-based data sharing system and its executive method.

### DETAILED DESCRIPTIONS OF THE PREFERRED EMBODIMENTS

For objects, characteristics, and effects obviously and easily understood, the preferred embodiments of the present invention are particularly interpreted as follows:

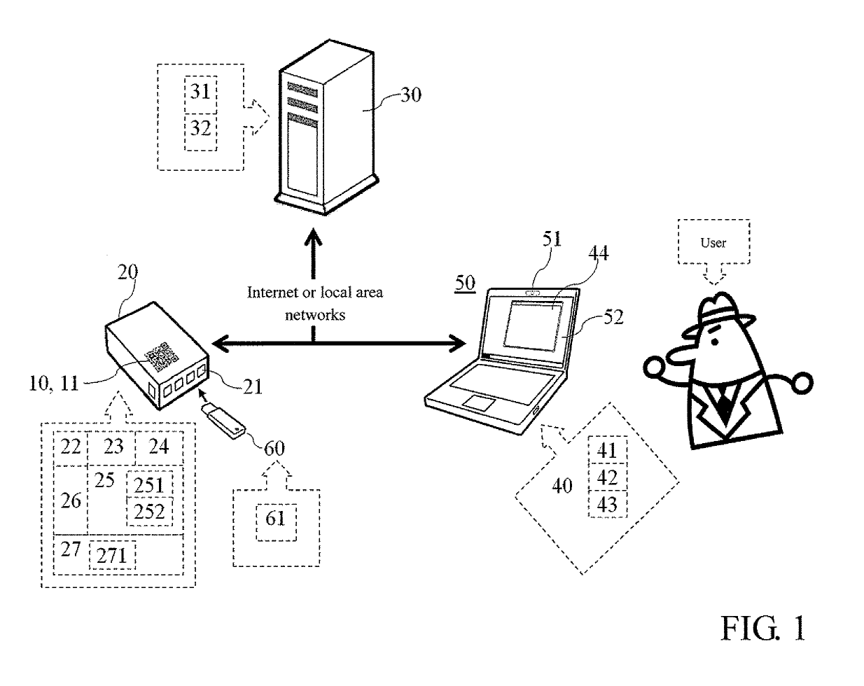

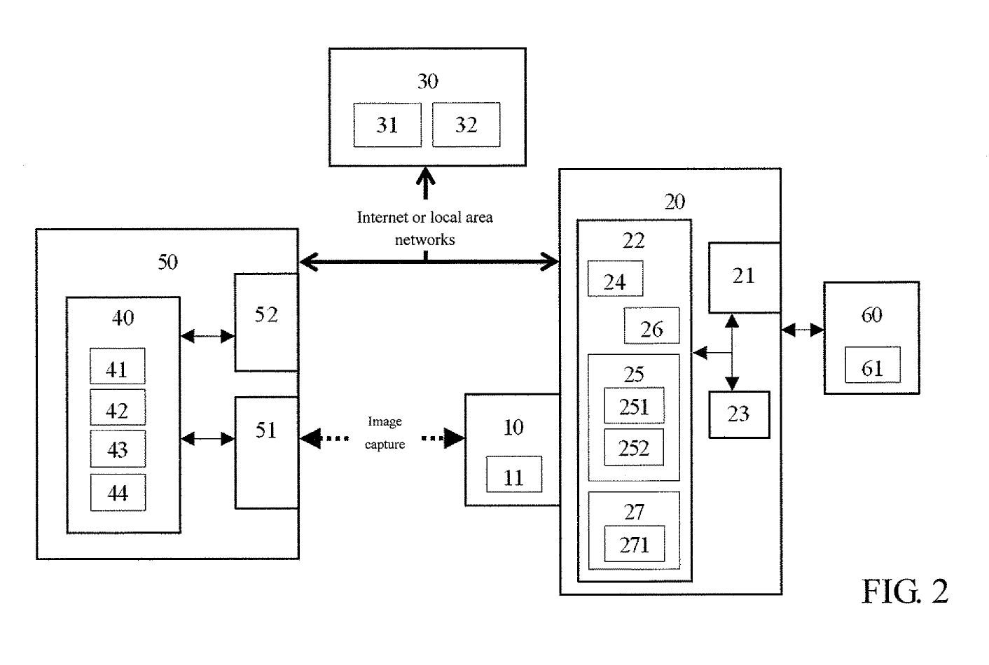

As shown in FIGS. 1, 2, 3a and 3b, the present invention of an image-based data sharing system and its executive method is dependent on Internet and local area networks for data sharing and comprises at least an image (10), at least a digital box (20), at least a server (30) and an application program (40). As shown in FIGS. 1 and 2, the icon or “ [symbol] or [symbol] ” implies Internet and local area networks connected; the icon “ [symbol] or [symbol] ” means electrical connection completed; the icon “ [symbol] ” implies an image caught.

Referring to FIGS. 1 and 2 which illustrate the image (10) generated from a specific encoding process comprises at least a peer authentication code (11). Preferably, the image (10) expresses its content comprising at least a server's position, a user name or a password or a combination of the server's position, the user name and the password. In this embodiment, the content expressed by the image (10) is the peer authentication code (11). In detail, the image (10) could be 1-dimensional (1D) barcodes or international standard 2-dimensional (2D) barcodes among Code16K, Supercode, Code49, QR code, PDF417, DataMatrix, Maxicode, Aztec, Vericode, Softstrip, Codel, CP, Codablock F, Ultracode, and Philips Dot Code. In addition, the image (10) includes, without limitation, gelatin film which is stuck on any surface of the digital box (20) or printed on a specific carrier (e.g., paper, plastic plate, etc.) or is saved in any computer and opened by any image scanning software. In this regard, the present invention should not be restricted to a position for preparation (existence) of an image which could be prepared or exist in any media (hardware or software) based on different models which have been classified to the prior arts. In this embodiment, the image (10) could be placed on any surface of the digital box (20).

Referring to FIGS. 1 and 2 which illustrate the application program (40) comprises an image capture module (41), a decoder module (42) and a connector module (43): the image capture module (41) is used to drive an image capture device (51) of one computer (50); the decoder module (42) is used in executing a decoding process in order to catch the peer authentication code (11) from the image (10); the connector module (43) is used to link and provide the peer authentication code (11) to the server (30). Preferably, the application program (40) still comprises a user interface (44) which is exported to one display unit (52) of the computer (50). Specifically, the application program (40) exists in at least a computer (50). In this regard, the present invention should not be restricted to methods based on the prior arts for the application program (40) delivered to the computers (50) via various media (software or hardware) such as Internet and storage device.

Specifically, the so-called electronic calculator (calculator or computer) is one machine which depends on a series of electronics-based commands for data processing. As tools used to process information, computers can be divided into numerous categories and include, without limitation, mobile device, personal computer (PC), desktop, Tablet PC, server, Smart Phone and Personal Digital Assistant (PDA).

Referring to FIGS. 1 and 2 which illustrate the digital box (20) links the server (30) via Internet or local area networks and comprises at least a data communications interface (21), at least a memory unit (22), at least a control unit (23), a peer authentication code (24) saved in the memory unit (22), and at least a file list (26): the control unit (23) is electrically connected to both the memory unit (22) and the data communications interface (21) and used to control access and processing of data.

The data communications interface (21) is electrically connected to at least a data storage device (60) which is used to store any data/file (61). Specifically, the data communications interface (21) could be any data communications interface among eSATA (External Serial ATA), eSATAp (power over eSATA) and USB (Universal Serial Bus) or a combination of these interfaces thereof which is electrically connected to the data storage devices (60) with various data communications interfaces.

Additionally, the memory unit (22) comprises a storage space (27) which is used to store any data/file (271).

Specifically, the memory unit (22) also comprises a programmable firmware (25) which has a file complier module (251) used to compile the data/file (61) of the data storage device (60) that is connected to the digital box (20) or the data/file (271) of the storage space (27) into the file list (26). Additionally, the programmable firmware (25) also comprises a connection module (252) which is executed by the control unit (23) of the digital box (20) in order to link and provide both the peer authentication code (24) and the file list (26) to the server (30).

Referring to FIGS. 1 and 2 again which illustrate the server (30) comprises at least a grouped peer management list (31) and at least a file management list (32): the grouped peer management list (31) is used to mange and confirm the peer authentication codes (11, 24) in the same group; the file management list (32) is used to manage the file list (26) which has been uploaded to the server (30);

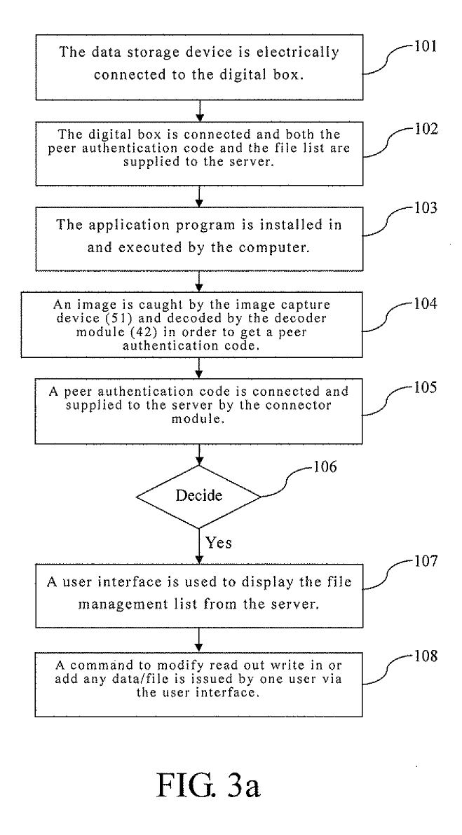

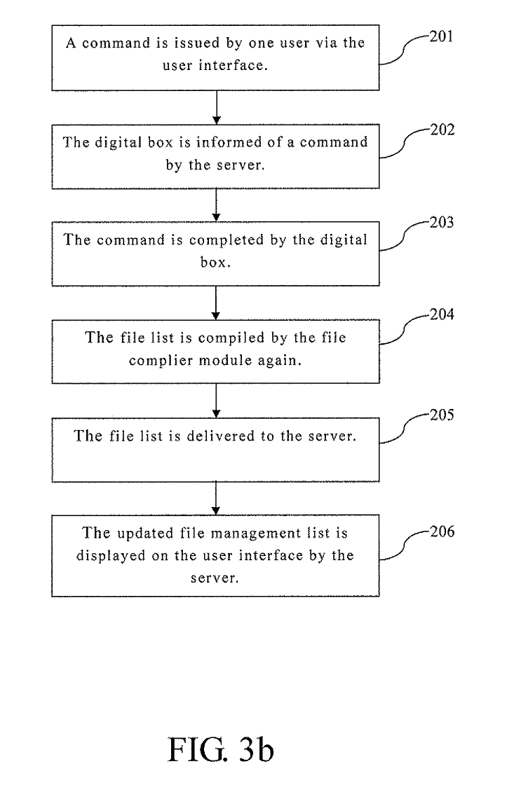

Referring to FIG. 3a which illustrates the detailed sequence to enable the embodiment: The data storage device (60) is electrically connected to the digital box (20) (Step 1: 101); the connection module (252) is executed by the control unit (23) of the digital box (20) for both the peer authentication code (24) and the file list (26) connected and supplied to the server (30) (Step 2: 102); The application program (40) is installed in and executed by the computer (50) (Step 3: 103); An image (10) is caught by the image capture device (51) and decoded by the decoder module (42) in order to get a peer authentication code (11) (Step 4: 104); A peer authentication code (11) is connected and supplied to the server (30) by the connector module (43) (Step 5: 105); The peer authentication codes are identified by the server (30) via the grouped peer management list (31) (Step 6: 106); A user interface (44) provided by the application program (40) is exported to one display unit (52) of the computer (50) and used to display the file management list (32) from the server (30) when the peer authentication code (11) of the image (10) and the peer authentication code (24) of the digital box (20) are identified as the same group by the server (30) (Step 7: 107); A command to modify, read out, write in or add any data/file (61) in the data storage device (60) which has been displayed on the management list (32) or any data/file (271) in the storage space (27) is issued by one user via the user interface (44) and the computer (50) (Step 8: 108).

In detail, a decoding process executed by the decoder module (42) at Step 4 is intended for decoding of the caught image (10) and the decoded peer authentication code (11) delivered to the computer (50); or, the decoding process executed by the decoder module (42) is intended for the caught image (10) supplied to the server (30) for decoding via the connection module (252) and the decoded peer authentication code (11) delivered to the computer (50) by the server (30).

On the other hand, please referring to FIG. 3b which illustrates the sequence of modifying (adding or deleting) any data/file: A command for modification, deletion or addition of any data/file is issued by one user via the user interface (44) (Step 1: 201); the digital box (20) is informed of a command for modification, deletion or addition of any data/file by the server (30) (Step 2: 202); the command is completed by the digital box (20) (Step 3: 203); the file list (26) is compiled by the file complier module (251) of the programmable firmware (25) again (Step 4: 204); the file list (26) is delivered to the server (30) (Step 5: 205); the updated file management list (32) is displayed on the user interface (44) for one user's check by the server (30) (Step 6: 206).

It can be seen from the above descriptions that the present invention is intended for data sharing via Internet or local area networks which is completed with at least a data storage device electrically connected to a digital box and the digital box linking a server. At this time, an image could be caught by the computer which is equipped with an application program via an image capture device and decoded by a decoder module in order to obtain a peer authentication code. When the computer's and the digital box's peer authentication codes are identified as the same group, any data/file in a data storage device which is electrically connected to a digital box or any data/file in a storage space of the digital box could be read out, written in, modified, deleted or added by one computer user, and the present invention is effective in: (1) Data sharing unrestricted to a distance between a digital box and a computer and data easily, effectively and conveniently shared; (2) File/data effectively managed and updated by one user to substantially eliminate difficulty in data management for one single file duplicated multiply; (3) Data security because of modification, read-out or write-in of any data/file in a data storage device which is connected to a digital box only available in a computer's and a digital box's peer authentication codes belonging to the same group.

As a result, the present invention with some effects different from other data sharing systems and their executive methods and referred to as creative work meets patentability and is applied for the patent.

It must be stressed that the said disclosures demonstrate the preferred embodiments of the present invention only and any equivalent change in disclosures, claims or drawings with respect to the present invention is still within the technical scope protected by the present invention which refers to claims hereinafter.

What is claimed is:

1. An image-based data sharing system which completes data sharing via Internet or local area networks comprises at least an image (10), at least a digital box (20), at least a server (30) and an application program (40):
The image (10) generated from a specific encoding process has its content comprising at least a peer authentication code (11);
The digital box (20) connected to the server (30) comprises at least a data communications interface (21), at least a memory unit (22), at least a control unit (23) and a peer authentication code (24) saved in the memory unit (22), and at least a file list (26) wherein the data communications interface (21) is electrically connected to at least a data storage device (60);
The server (30) comprises at least a grouped peer management list (31), which is used to manage and identify the peer authentication codes (11, 24) in the same group, and at least a file management list (32), which is used to manage the file list (26) uploaded to the server (30);
The application program (40) comprises an image capture module (41) which is used to drive an image capture device (51) of one computer (50), a decoder module (42) which executes a decoding process to get the peer authentication code (11) when the image (10) is caught by the image capture device (51), and a connector module (43) which is used to link and provide the peer authentication code (11) to the server (30); the data/file (61) in the data storage device (60) which is connected to the data communications interface (21) of the digital box (20) can be modified, read out, or written in via the computer (50) when both the peer authentication code (11) of the image (10) and the peer authentication code (24) of the digital box (20) are identified as the same group by the server (30) via the grouped peer management list (31).

2. The image-based data sharing system according to claim 1 wherein the memory unit (22) of the digital box (20) comprises a storage space (27) used to store any data/file (271).

3. The image-based data sharing system according to claim 1 wherein the memory unit (22) comprises a programmable firmware (25) with one file complier module (251) which is used to compile a data/file (61) of the data storage device (60) which is connected to the digital box (20).

4. The image-based data sharing system according to claim 3 wherein the programmable firmware (25) comprises a connection module (252) which is executed by the control unit (23) for both the peer authentication code (24) and the file list (26) provided to the server (30).

5. The image-based data sharing system according to Claim wherein the image (10) has its content comprising at least a server's position, a user name or a password or a combination of the server's position, the user name and the password.

6. The image-based data sharing system according to claim 1 wherein a user interface (44) provided by the application program (40) is exported to one display unit (52) of the computer (50) and used to display the file management list (32) from the server (30) when both the peer authentication code (11) of the image (10) and the peer authentication code (24) of the digital box (20) are identified as the same group by the server (30).

7. The image-based data sharing system according to claim 6 wherein a command to modify, read out, write in or add a data/file (61) which is saved in the data storage device (60) and displayed on the file management list (32) or a data/file (271) in the storage space (27) is issued by one user using the user interface (44) and the computer (50).

8. The image-based data sharing system according to claim 1 wherein the data communications interface (21) of the digital box (20) could be any data communications interface among eSATA (External Serial ATA), eSATAp (power over eSATA) and USB (Universal Serial Bus) or a combination of these interfaces thereof.

9. The image-based data sharing system according to claim 1 wherein a decoding process executed by the decoder module (42) is used to decode the caught image (10) and the decoded peer authentication code (11) is delivered to the computer (50).

10. The image-based data sharing system according to claim 4 wherein a decoding process executed by the decoder module (42) is used to decode the caught image (10) which is supplied to the server (30) via the connection module (252) and the decoded peer authentication code (11) is delivered to the computer (50) by the server (30).

11. The image-based data sharing system according to claim 2 wherein the memory unit (22) comprises a programmable firmware (25) with one file complier module (251) which is used to compile a data/file (61) of the data storage device (60) which is connected to the digital box (20) or a data/file (271) of the storage space (27) into the file list (26).

12. The image-based data sharing system according to claim 11 wherein the programmable firmware (25) comprises a connection module (252) which is executed by the control unit (23) for both the peer authentication code (24) and the file list (26) provided to the server (30).

13. The image-based data sharing system according to claim 12 wherein a decoding process executed by the decoder module (42) is used to decode the caught image (10) which is supplied to the server (30) via the connection module (252) and the decoded peer authentication code (11) is delivered to the computer (50) by the server (30).

14. The image-based data sharing system according to claim 1 wherein the image (10) could be 1-dimensional (1D) barcodes or international standard 2-dimensional (2D) barcodes among Code16K, Supercode, Code49, QR code, PDF417, DataMatrix, Maxicode, Aztec, Vericode, Softstrip, Codel, CP, Codablock F, Ultracode, and Philips Dot Code.

15. An executive method of an image-based data sharing system via Internet or local area networks comprises steps as follows:
Step 1: The data storage device (60) is electrically connected to the digital box (20);
Step 2: The connection module (252) is executed by the control unit (23) of the digital box (20) for both the peer authentication code (24) and the file list (26) connected and supplied to the server (30);
Step 3: The application program (40) is installed in and executed by the computer (50);
Step 4: An image (10) is caught by the image capture device (51) and decoded by the decoder module (42) in order to get a peer authentication code (11);
Step 5: The connector module (43) links and provides a peer authentication code (11) to the server (30);
Step 6: The peer authentication codes are identified by the server (30) via the grouped peer management list (31);
Step 7: A user interface (44) provided by the application program (40) is exported to one display unit (52) of the computer (50) and used to display the file management list (32) from the server (30) when both the peer authentication code (11) of the image (10) and the peer authentication code (24) of the digital box (20) are identified as the same group by the server (30);
Step 8: A command to modify, read out, write in or add any data/file (61) which is saved in the data storage device (60) and displayed on the file management list (32) or any data/file (271) in the storage space (27) is issued by one user via the user interface (44) and the computer (50).
